(19) United States
(12) Patent Application Publication
(10) Pub. No.: US 2023/0182386 A1
(43) Pub. Date: Jun. 15, 2023

(54) CONVEYING MECHANISM FOR 3D PRINTER

(71) Applicant: SHENZHEN KYWOO 3D TECHNOLOGY CO., LTD., Shenzhen (CN)

(72) Inventor: GUOLIANG JI, Shenzhen (CN)

(21) Appl. No.: 17/580,661

(22) Filed: Jan. 21, 2022

(30) Foreign Application Priority Data
Dec. 15, 2021 (CN) 202123169850.9

(51) Int. Cl. B29C 64/245; B33Y 30/00; B29C 64/236; B29C 64/364; B33Y 40/00

(52) U.S. Cl. CPC B29C 64/245; B33Y 30/00; B29C 64/236; B29C 64/364; B33Y 40/00

(57) ABSTRACT

A conveying mechanism for a 3D printer includes a base and a conveying structure disposed on the base. The conveying structure includes a frame, a driving wheel assembly, and a conveyor belt. The conveyor belt is a metal conveyor belt. A PEI coating is sprayed on an outer surface of the metal conveyor belt. A printing nozzle mechanism is disposed above the conveying structure. Rigidity of the metal conveyor belt is high, and the conveyor belt itself has no elasticity. Even when a squeezing force is generated between the printing nozzle and the conveyor belt, the conveyor belt does not deform, which improves printing accuracy. In addition, the outer surface of the metal conveyor belt is sprayed with the PEI coating to improve adhesion and friction between the metal conveyor belt and printing material.

### TECHNICAL FIELD

The present disclosure relates to a field of 3D printing technology, and in particular to a conveying mechanism for a 3D printer.

### BACKGROUND

A 3D printer is a machine that realizes rapid prototyping technology. It is a kind of machine based on a digital model file, adopting fusion lamination technology, using powder metal, plastic, or other bondable materials to construct an object by layer-by-layer printing technology.

In a conventional 3D printer, a conveyor belt works in conjunction with aprinting nozzle. In a process of printing a model by the printing nozzle, the conveyor belt continuously brings out a printed portion of the model, making printing space unrestricted.

However, the conventional 3D printer has following defects. Because the conveyor belt is commonly made of flexible materials such as rubber or cloth, the conveyor belt has a certain elasticity. During a process of extruding material from the printing nozzle, there is a squeezing force between a nozzle of the printing nozzle and the conveyor belt. Under action of the squeezing force, the conveyor belt is prone to deformation due to the elasticity of the conveyor bel, which greatly affects printing accuracy and seriously affects printing effect.

Therefore, it is necessary to design a conveying mechanism for a 3D printer to solve above problems.

### SUMMARY

The present disclosure provides a conveying mechanism for a 3-dimension (3D) printer, which is configured to solve a problem that a conveying belt of a conventional 3D printer has a certain elasticity, which affects printing accuracy.

In order to solve the above-mentioned problems, the present provides the following technical solutions.

The present disclosure provides a conveying mechanism for a 3-dimension (3D) printer. The conveying mechanism for the 3D printer comprises a base and a conveying structure disposed on the base.

The conveying structure comprises a frame, a driving wheel assembly, and a conveyor belt.

The conveyor belt is a metal conveyor belt. A polyethylenimine (PEI) coating is sprayed on an outer surface of the metal conveyor belt.

A printing nozzle mechanism is disposed above the conveying structure.

Furthermore, the metal conveyor belt is made of stainless steel.

Furthermore, a thickness of the metal conveyor belt ranges from 0.02-0.2 mm.

Furthermore, the thickness of the metal conveyor belt ranges from 0.08-0.12 mm.

Furthermore, the driving wheel assembly comprises driving rollers and motors. A horizontal adjusting mechanism is disposed between the driving rollers and the frame. The horizontal adjusting mechanism is configured to adjust tension of the conveyor belt.

Furthermore, a height fine-tuning assembly is disposed between the conveying structure and the base. The height fine-tuning assembly comprises screw rods and springs. The height fine-tuning assembly connects the conveying structure and the base.

Furthermore, the printing nozzle mechanism comprises a support frame, a moving mechanism, and a printing nozzle, the support frame is placed at an acute angle with respect to the frame. The moving mechanism comprises a horizontal moving portion and a vertical moving portion. The printing nozzle is connected with the moving mechanism.

Furthermore, the printing nozzle is disposed at an angle of 45 degrees with respect to the conveyor belt.

Furthermore, the printing nozzle mechanism further comprises a cooling fan; the cooling fan faces the printing nozzle.

The conveyor belt of the conveying mechanism for the 3D printer of the present disclosure is the metal conveyor belt. Rigidity of the metal conveyor belt is high, and the conveyor belt itself has no elasticity. Even when a squeezing force is generated between the printing nozzle and the conveyor belt, the conveyor belt does not deform, which improves printing accuracy. In addition, the outer surface of the metal conveyor belt is sprayed with the PEI coating to improve adhesion and friction between the metal conveyor belt and printing material.

### BRIEF DESCRIPTION OF DRAWINGS

In order to clearly illustrate embodiments of the present disclosure or the technical solutions in the prior art, following briefly introduces the accompanying drawings that need to be used in the description of the embodiments or the prior art. Obviously, the accompanying drawings in the following description are just some embodiments of the present disclosure, and for those of ordinary skill in the art, other drawings can also be obtained from these drawings without creative effort.

FIG. 1 is a schematic diagram showing an overall structure of a conveying mechanism for a 3D printer according to one embodiment of the present disclosure.

FIG. 2 is a schematic diagram of a base and a conveying structure according to one embodiment of the present disclosure.

FIG. 3 is a side schematic diagram of the conveying structure according to one embodiment of the present disclosure.

FIG. 4 is an enlarged view of area A shown in FIG. 3.

FIG. 5 is a schematic diagram of a conveyor belt according to one embodiment of the present disclosure.

FIG. 6 is a schematic diagram of a printing nozzle mechanism according to one embodiment of the present disclosure.

### DETAILED DESCRIPTION

Technical solutions in the embodiments of the present disclosure will be clearly and completely described below with reference to the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure. It is understood that the accompanying drawings are only for reference and descriptive purpose only and are not used to limit the present disclosure. The connection relationship shown in the drawings is only for clear description, and does not limit the connection manner.

The inventor of the present disclosure have found that in a 3D printer of the prior art, during a printing process of the printing nozzle, a relative squeezing force is generated between the printing nozzle and the conveyor belt, resulting in deformation of the conveyor belt, affecting accuracy of 3D printing. In addition, the adhesion and friction of the conventional conveyor belt to printing material are not enough, which affects the printing effect.

In view of this, the present disclosure discloses a conveying mechanism for a 3D printer, which aims to provide a conveying mechanism for a 3D printer that does not produce sufficient deformation and provides enough adhesion and friction.

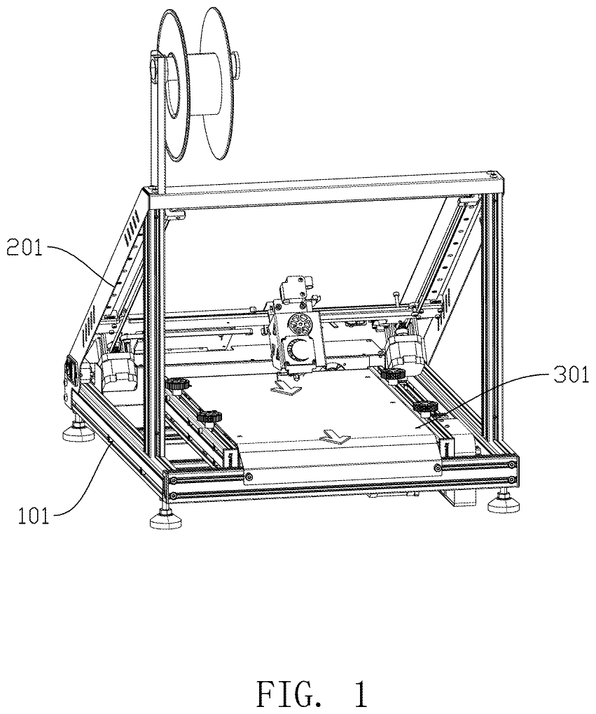

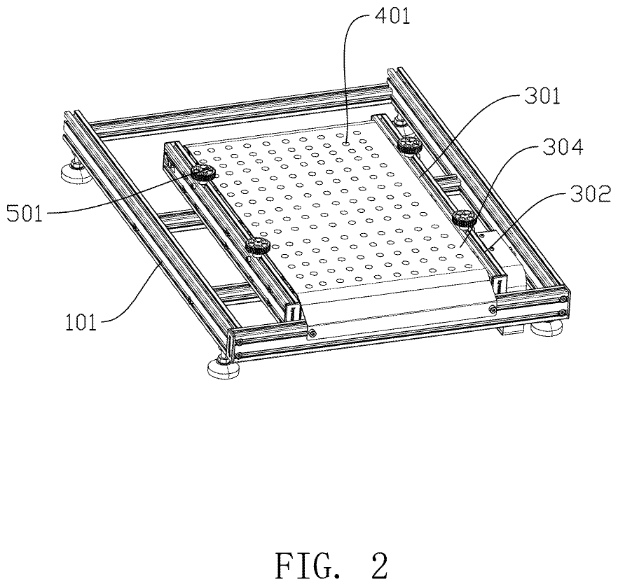

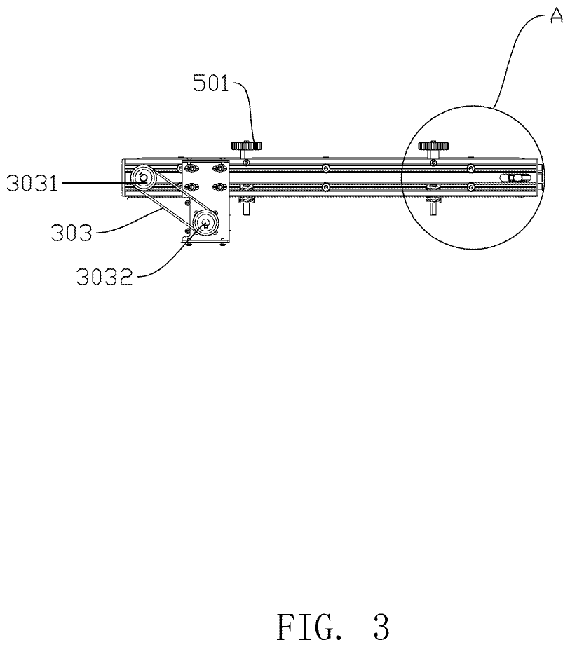

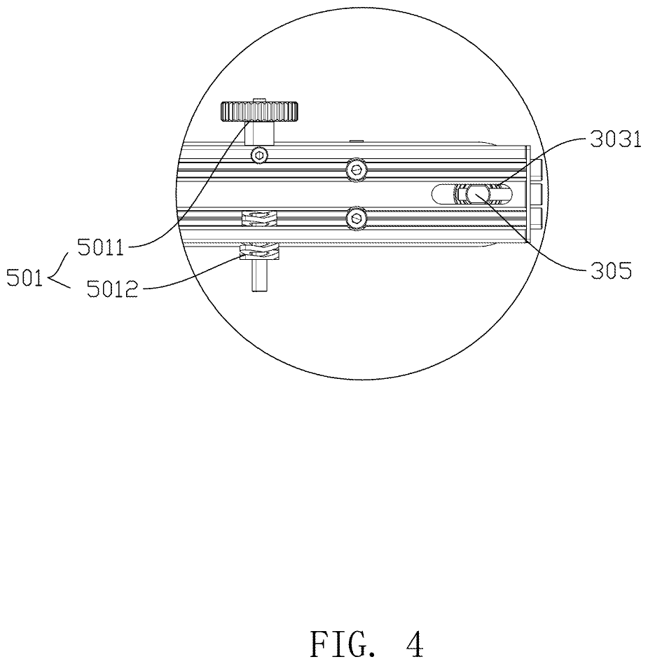

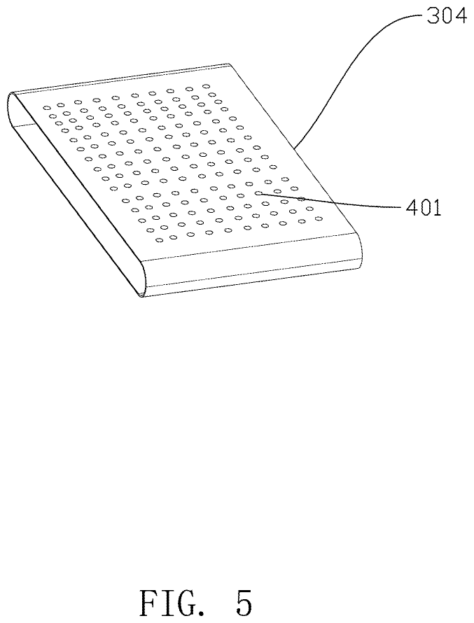

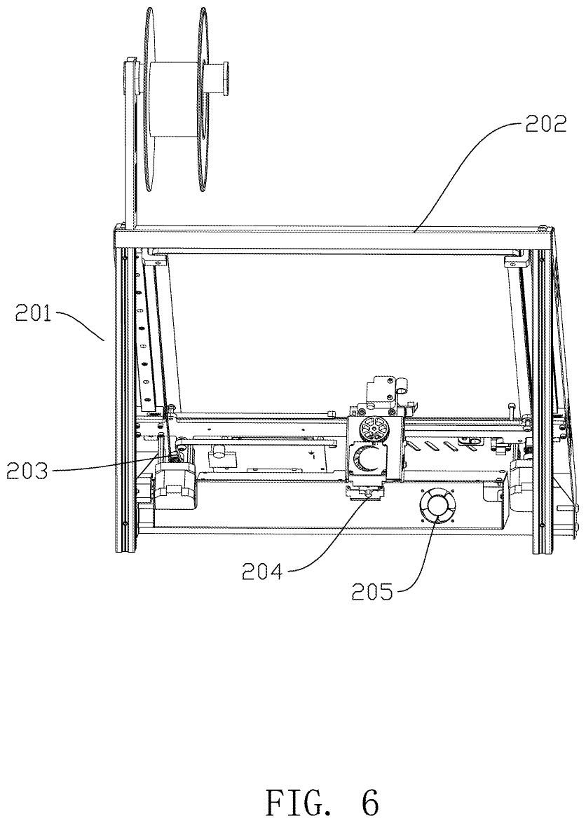

As shown in FIGS. 1-6, the conveying mechanism for the 3D printer comprises a base 101 and a conveying structure 301 disposed on the base 101. The conveying structure 301 comprises a frame 302, a driving wheel assembly 303, and a conveyor belt 304. The conveyor belt 304 is a metal conveyor belt. A polyethylenimine (PEI) coating 401 is sprayed on an outer surface of the metal conveyor belt. A printing nozzle mechanism 201 is disposed above the conveying structure 301.

The conveyor belt 304 of the conveying mechanism for the 3D printer of the present disclosure is the metal conveyor belt. Rigidity of the metal conveyor belt is high, and the conveyor belt 304 itself has no elasticity. Even when the squeezing force is generated between the printing nozzle and the conveyor belt 304, the conveyor belt 304 does not deform, which improves printing accuracy. In addition, the outer surface of the metal conveyor belt is sprayed with the PEI coating 401 to improve adhesion and friction between the metal conveyor belt and printing material, so during a printing process, the model is not displaced, thereby improving printing quality and effect.

In one embodiment, the metal conveyor belt is made of stainless steel.

Optionally, a thickness of the metal conveyor belt ranges from 0.02-0.2 mm.

Specifically, the thickness of the metal conveyor belt ranges from 0.08-0.12 mm. In one optional embodiment, the thickness of the metal conveyor belt is 0.1 mm.

The driving wheel assembly 303 of the present disclosure comprises driving rollers 3031 and a motors 3032. A horizontal adjusting mechanism 305 is disposed between the driving rollers 3031 and the frame. A horizontal position of the driving rollers 3031 is adjusted by toggling the horizontal adjustment mechanism 305, so as to adjust tension of the conveyor belt 304.

Furthermore, a height fine-tuning assembly 501 is disposed between the conveying structure 301 and the base 101. The height fine-tuning assembly 501 comprises screw rods 5011 and springs 5012. On one hand, he height fine-tuning assembly 501 connects the conveying structure and the base. On the other hand, by screwing the screw rods 5011, a compression degree of the springs is adjusted, so a horizontal angle of the conveying structure 301 is fine-tuned.

In the embodiment, the printing nozzle mechanism 201 comprises a support frame 202, a moving mechanism 203, and a printing nozzle 204. The support frame 202 is placed at an acute angle with respect to the frame 302. The moving mechanism 203 comprises a horizontal moving portion and a vertical moving portion. The printing nozzle 20 is connected with the moving mechanism 203. The printing nozzle 204 is disposed at an angle of 45 degrees with respect to the conveyor belt 304, which ensures that no support is required when printing a hollow model, and the hollow model is printed continuously without interruption.

Furthermore, the printing nozzle mechanism 201 further comprises a cooling fan 205. The cooling fan 205 faces the printing nozzle 204. The cooling fan 205 is configured to dissipate heat generated by the printing nozzle 204 during the printing process.

In the description and claims of the present disclosure, terms such as “include”, “comprise”, “have”, “contain”and variations thereof are used to designate the presence of stated features, values, steps or components, which do not preclude the presence or addition of one or multiple other features, values, steps, components, or combinations thereof.

Some features of the present disclosure, for clarity of illustration, are described in separate embodiments. However, these features may also be described in combination in a single embodiment. Similarly, some features of the present disclosure are, for brevity, only described in a single embodiment, however, these features may also be described in different embodiments alone or in any suitable combination.

The above are only optional embodiments of the present disclosure, and are not intended to limit the present disclosure. Any modifications, equivalent replacements, and improvements made within the spirit and principles of the present disclosure shall be included in the protection scope of the present disclosure.

What is claimed is:

1. A conveying mechanism for a 3-dimension (3D) printer, comprising a base and a conveying structure disposed on the base;
wherein the conveying structure comprises a frame, a driving wheel assembly, and a conveyor belt;
wherein the conveyor belt is a metal conveyor belt; a polyethylenimine (PEI) coating is sprayed on an outer surface of the metal conveyor belt;
wherein a printing nozzle mechanism is disposed above the conveying structure.

2. The conveying mechanism for the 3D printer according to claim 1, wherein the metal conveyor belt is made of stainless steel.

3. The conveying mechanism for the 3D printer according to claim 2, wherein a thickness of the metal conveyor belt ranges from 0.02-0.2 mm.

4. The conveying mechanism for the 3D printer according to claim 3, wherein the thickness of the metal conveyor belt ranges from 0.08-0.12 mm.

5. The conveying mechanism for the 3D printer according to claim 1 wherein the driving wheel assembly comprises driving rollers and motors; a horizontal adjusting mechanism is disposed between the driving rollers and the frame; the horizontal adjusting mechanism is configured to adjust tension of the conveyor belt.

6. The conveying mechanism for the 3D printer according to claim 1, wherein a height fine-tuning assembly is disposed between the conveying structure and the base; the height fine-tuning assembly comprises screw rods and springs; the height fine-tuning assembly connects the conveying structure and the base.

7. The conveying mechanism for the 3D printer according to claim 1, wherein the printing nozzle mechanism comprises a support frame, a moving mechanism, and a printing nozzle; the support frame is placed at an acute angle with respect to the frame; the moving mechanism comprises a horizontal moving portion and a vertical moving portion; the printing nozzle is connected with the moving mechanism.

8. The conveying mechanism for the 3D printer according to claim 7, wherein the printing nozzle is disposed at an angle of 45 degrees with respect to the conveyor belt.

9. The conveying mechanism for the 3D printer according to claim 8, wherein the printing nozzle mechanism further comprises a cooling fan; the cooling fan faces the printing nozzle.
